(19) United States
(12) Patent Application Publication
(10) Pub. No.: US 2007/0193148 A1
(43) Pub. Date: Aug. 23, 2007

(54) End cap

(76) Inventors: Peter J. Simko, Barrie (CA); Miro Glisch, Toronto (CA)

Correspondence Address: Ralph A. Dowell of DOWELL & DOWELL P.C., 2111 Eisenhower Ave, Suite 406, Alexandria, VA, 22314, US

(21) Appl. No.: 11/346,555

(22) Filed: Feb. 3, 2006

(51) Int. Cl. E04H 12/00; E06B 3/70

(52) U.S. Cl. 52/300; 52/456

(57) ABSTRACT

An end cap comprises a base and at least one finger extending in a first direction from the base. A plurality of sets of flexible fins can be provided, each set of fins comprising first and second fins extending generally from the finger in an orientation that is generally orthogonal to the first direction. Each set of fins can be being positioned longitudinally along an axis oriented generally in the first direction wherein the first and second fins are movable independently of each other. The first and second fins are resiliently displaceable and movable generally in the first direction. The first and second fins can be resiliently displaceable. The end cap can be used in association with a construction member whereby the finger is inserted into the channel. More than one such finger can be provided.

### FIELD OF THE INVENTION

This invention relates to end caps for use with channeled members such as hollow channeled construction members.

### BACKGROUND

Construction members used in construction, both residential and commercial, are made from a wide variety of materials such as lumber, steel, aluminum as well as plastics and composite materials including but not limited to composite materials that combine one or more resins/plastics with one or more fibers, including man-made and natural fibers.

As is well known, with the advent of newer materials such as composites including composite woods and composite fiber products, and plastics, it is possible to make structurally efficient members that often have hollow channel profiles. Some examples of hollow profiles are illustrated in U.S. Pat. Nos. 6,826,884; 6,844,040; and 6,651,398, the contents of which are in their entirety hereby incorporated herein by reference.

However there are disadvantages of using such hollow channel profile members including the fact that if not plugged or drained, the hollow channels can become a place where significant amounts of moisture can collect and/or travel down. The result can be that moisture may be directed into undesirable locations in a building. Also moisture that is retained in the hollow channels, may not easily evaporate away and this can result in bacteria, mildew etc forming in the channels. Additionally, some of the new materials while resistant to absorbing moisture, may, if exposed to moisture for a significant period of time, begin to absorb moisture, possibly with deleterious effects.

Other problems are associated with the channels are that they can accumulate debris and dirt, as well as attracting insects to the hollow channels.

Another drawback of using hollow channel profile members is that the end profiles are generally not considered to be aesthetically pleasing to the eye.

Accordingly, the need has been recognized to provide end plugs or end caps to attempt to seal and/or cover up the end channels of the construction members. However, known end caps have drawbacks including but not limited to their ability to be received into the channels but also be maintained in position during the lifetime of use of the member. This is particularly the case when the construction members are subjected to significant changes in temperatures. For example, when heated, such as by the environment, the end plugs may not expand to the same degree as the construction member, tending to allow the end cap to become dislodged.

Additional difficulties in providing a suitable end cap arise due to difficulties in maintaining precise dimensional tolerances in the manufacturing processes of the construction members. There may be some variations in size dimensions as between the same type of construction members as a whole (i.e. one board varies in at least some dimensions from another board. There may also or alternatively be variations in sizes of parts that are intended to be the same size (e.g. different channels in the same construction member might have variations on the dimensions of the channels.

Accordingly, an improved end cap is desired.

### SUMMARY

In accordance with an aspect of the present invention there is provided an end cap comprising a) a base having at least one surface; b) at least one finger extending outwards in a first direction from the at least one surface of the base; and c) at least one set of fins comprising first and second flexible fins extending outwardly generally from the at least one finger in an orientation that is generally orthogonal to the first direction, the fins being generally positioned on opposite sides of the finger; with at least a portion of the finger, the first and second fins being insertable into channel of a construction member such that each of the first and second fins is displaced and engages and exerts a force against an inner wall surface of the channel, whereby the end cap can be held in a fixed position relative to the construction member.

According to another aspect of the invention there is provided an end cap comprising: a base; a) at least one finger extending in a first direction from the base; b) a plurality of sets of fins each set of fins comprising a plurality of fins extending generally from the finger in an orientation that is generally orthogonal to the first direction, with at least a portion of the finger, and the plurality of sets of fins being insertable into a channel of a construction member such that each of the fins of the plurality of fins engages and provides a frictional engagement with an inner wall surface of the channel, whereby the end cap can be held in a fixed position relative to the construction member.

According to another aspect of the invention there is provided an end cap comprising: a base; at least one finger extending in a first direction from said base; and a plurality of sets of flexible fins each set of fins comprising first and second fins extending generally from said finger in an orientation that is generally orthogonal to said first direction, each set of fins being positioned longitudinally along an axis oriented generally in said first direction wherein said first and second fins are movable independently of each other.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In figures which illustrate by way of example only, embodiments of this invention:

FIG. 1 is a top, rear perspective view of an end cap;

FIG. 1A is a front, top perspective view of the end cap of FIG. A in use, prior to insertion into the end of hollow channels of a construction member; and

FIG. 1B is a vertical cross section view at 1B-1B in FIG. 1A, after the end cap has been inserted into the construction member

FIG. 2 is a bottom, front perspective view of the end cap of FIG. 1;

FIG. 3 is a rear elevation view of the end cap of FIG. 1;

FIG. 4 is right side view of the end cap of FIG. 1; the left side view is a mirror image;

FIG. 5 is top plan view of the end cap of FIG. 1; the bottom plan view is the same as FIG. 5;

FIG. 6 is front elevation view of the end cap of FIG. 1;

FIG. 7 is a top, rear perspective view of a first alternate embodiment of an end cap;

FIG. 8 is a bottom, front perspective view of the end cap of FIG. 7;

FIG. 9 is a rear elevation view of the end cap of FIG. 7;

FIG. 10 is right side view of the end cap of FIG. 7; the left side view is a mirror image;

FIG. 11 is top plan view of the end cap of FIG. 7; the bottom plan view is the same as FIG. 11;

FIG. 12 is front elevation view of the end cap of FIG. 7;

FIG. 13 is a top, rear perspective view of a second alternate embodiment of an end cap;

FIG. 14 is a bottom, front perspective view of the end cap of FIG. 13;

FIG. 15 is a rear elevation view of the end cap of FIG. 13;

FIG. 16 is right side view of the end cap of FIG. 13; the left side view is a mirror image;

FIG. 17 is top plan view of the end cap of FIG. 13; the bottom plan view is the same as FIG. 17;

FIG. 18 is front elevation view of the end cap of FIG. 13;

FIG. 19 is a top, rear perspective view of a third alternate embodiment of an end cap;

FIG. 20 is a bottom, front perspective view of the end cap of FIG. 19;

FIG. 21 is a rear elevation view of the end cap of FIG. 19;

FIG. 22 is right side view of the end cap of FIG. 19; the left side view is a mirror image;

FIG. 23 is top plan view of the end cap of FIG. 19; the bottom plan view is the same as FIG. 23;

FIG. 24 is front elevation view of the end cap of FIG. 19;

FIG. 25 is a top, rear perspective view of a fourth alternate embodiment of an end cap;

FIG. 26 is a bottom, front perspective view of the end cap of FIG. 25;

FIG. 27 is a rear elevation view of the end cap of FIG. 25;

FIG. 28 is right side view of the end cap of FIG. 25; the left side view is a mirror image;

FIG. 29 is top plan view of the end cap of FIG. 25; the bottom plan view is the same as FIG. 29;

FIG. 30 is front elevation view of the end cap of FIG. 25;

FIG. 31 is a top, rear perspective view of a fifth alternate embodiment of an end cap;

FIG. 32 is a bottom, front perspective view of the end cap of FIG. 31;

FIG. 33 is a rear elevation view of the end cap of FIG. 31;

FIG. 34 is right side view of the end cap of FIG. 31; the left side view is a mirror image;

FIG. 35 is top plan view of the end cap of FIG. 31; the bottom plan view is the same as FIG. 35; and

FIG. 36 is front elevation view of the end cap of FIG. 31.

### DETAILED DESCRIPTION

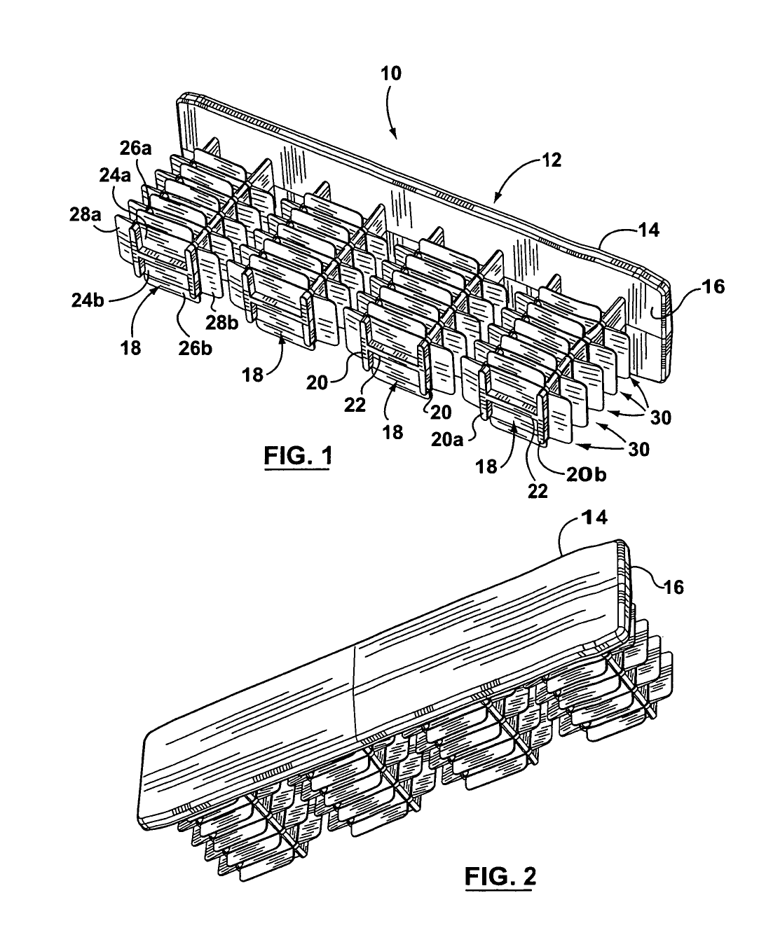

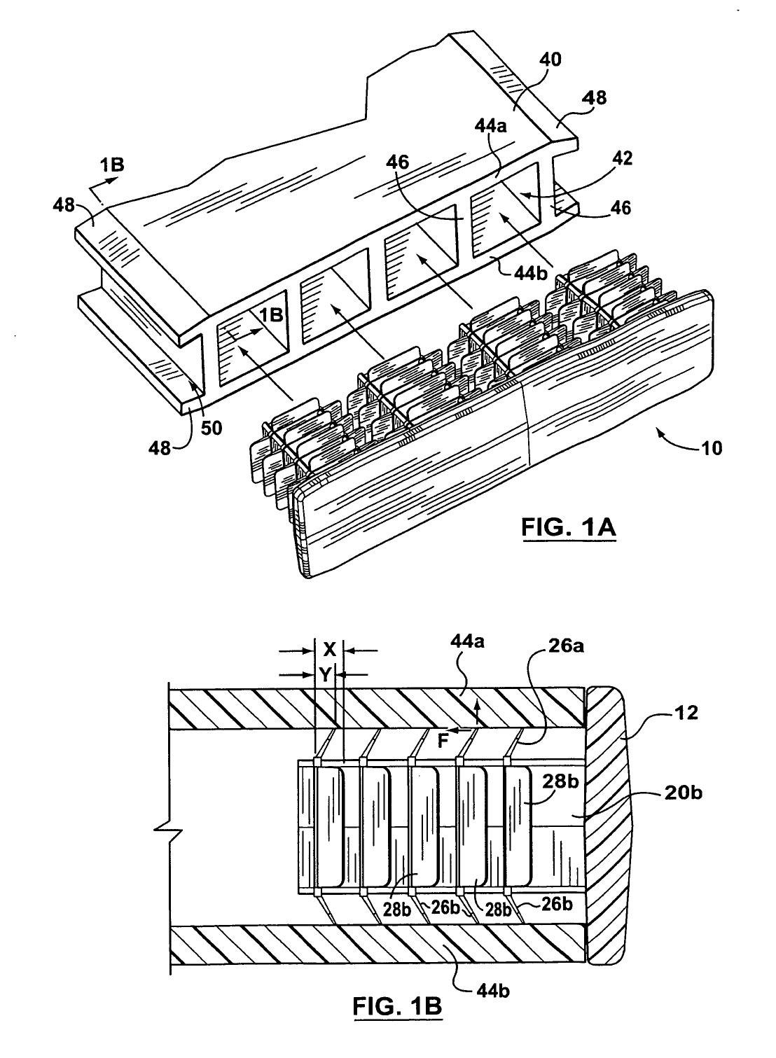

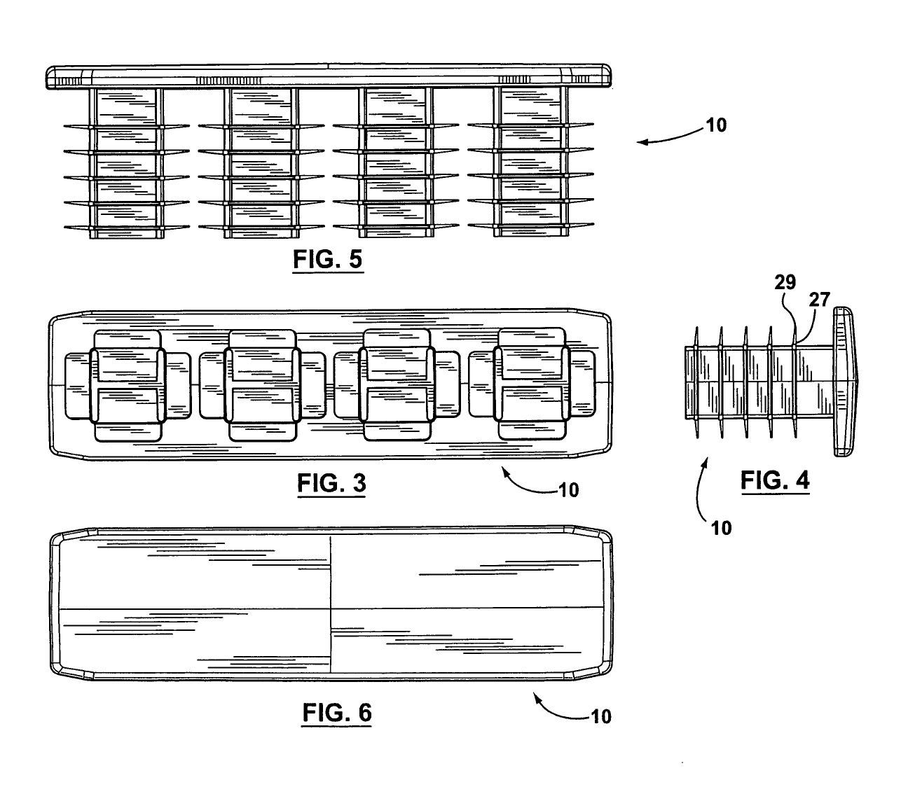

With reference to FIGS. 1-6, an end cap 10 is illustrated which is suitable for use in co-operation with a construction member (not shown in FIGS. 1-6). End cap 10 can be made of any suitable material including but not limited to a plastic such as by way of example only high density polypropylene or high density polyethylene. In other example embodiments, the end cap could be made with a suitable metal such as by way of example aluminum, or a composite material.

In typical example embodiments the end cap can be cost effectively made from a suitable plastic material by known injection molding techniques, although other materials and manufacturing processes could be employed.

The material can be selected such that it has a co-efficient of thermal expansion, which is similar or substantially identical to the material from which the construction member is made. This will assist in ensuring that during heating or cooling of the construction member and end cap, such as due to external environmental conditions, there will be similar degrees of contraction/expansion of the end cap 10 and the construction member with which is will be used. However, similar coefficients of thermal contraction and expansion are not necessary as end cap 10 can accommodate different levels of expansion and contraction of the end cap and the construction member.

End cap 10 may, as illustrated, be formed generally as a generally flat plate. However, depending upon the particular application, other configurations are possible. As illustrated end cap 10 has a base 12, which is shown in FIGS. 1-6 as a generally planar plate with generally planar opposed, front surface 14 and rear surface 16. Rear surface 16 is, in this example embodiment, generally planar. Front surface 14 has in this example embodiment, a slight crown on the front surface extending in both the horizontal and vertical directions. However, other configurations for surfaces are possible but are generally selected to be physically and/or aesthetically compatible with the construction member with which they are used.

Extending generally orthogonal to, and outward from, rear surface 16, are a plurality of finger members 18. Finger members are generally rigid or semi-rigid in most embodiments. However is some example embodiments they may be able to deform (preferably resiliently) in the upward and downward direction. In the illustrated example embodiment, each finger 18 is formed from a generally H-shaped (i.e. a rotated I-beam) member having vertically and longitudinally extending flange members 20a, 20b, interconnected at a medial portion along their length by a horizontal and longitudinally extending web member 22. A plurality of spaced, opposed pairs of wall members 24a and 24b extend vertically up and down from opposite horizontally disposed inner surfaces of web 22 and the inward facing surfaces of flanges 20a, 20b. Wall members 24a and 24b act as reinforced diaphragm members.

Extending outward from the fingers 18 and which may, as in this embodiment, be integrally formed as part of the finger 18, are spaced sets of flexible and resilient fins generally designated 30. Each set of fins 30 may include a first set of opposed fins 26a, 26b, which are oriented vertically and extend outwardly from diaphragm members 24a and 24b respectively. Each set of fins 30 also includes a second set of opposed fins 28a, 28b, which are oriented horizontally. Opposed fins 28a, 28b extend horizontally outwards from outward facing surfaces of opposed flanges 20a, 20b. Opposed fins 26a, 26b may, as illustrated, be formed as extensions of upward and downwardly depending wall members 24a, 24b.

Each of the individual fins may in some example embodiments be uniform in side view and in other example embodiments, be generally configured as being generally narrowing (e.g. tapering uniformly or non-uniformly) in side view, or side section, particularly as shown in FIGS. 4 and 5. Accordingly, each fin may be configured to generally narrow from a base 27 toward a tip 29. The effect of this is that the degree of flexibility will vary from base 27 toward tip 29. In the illustrated embodiment, the closer the location is toward the tip 29, the less resistance there in the fin to bending (i.e. the more flexibility).

It will also be noted that in the embodiment of FIGS. 1-6, each fin 26a, 26b, 28a, 28b, is not physically interconnected directly to an adjacent fin. By way of example, a fin 28a is not joined on either side edge to a side edge of either adjacent fins 26a. In this way, each fin 26a can move independently of the adjacent fins 28a, 28b.

In other embodiments, there may not be complete disconnection between adjacent fins, but there is sufficient disconnection between adjacent fins to enable each fin to have at least some amount of movement that is independent of the adjacent fins.

With reference now to FIGS. 1A and 1B, end cap 10 is shown in use with a construction member 40. Construction member 40 may be a deck board such as a deck board as is disclosed in U.S. Pat. No. 6,651,398 the contents of which is incorporated herein by reference in its entirety. Member 40 has a top plate 44a and bottom plate 44b interconnected by a plurality of spaced, longitudinally extending, vertically oriented webs 46. Thus, a plurality of longitudinally extending, hollow channels 42 are formed in construction member 40. Additionally, member 40 has pair so opposed lips 48 which are used in mounting the deck board 40 to a supporting joist. As is shown in FIG. 1A, unenclosed, hollow end channels 50 are also formed in deck board 40.

As shown in FIGS. 1A and 1B, the fingers 18 of end cap 10 are received into the ends of hollow channels 42 of deck board 40. It will be noted that the footprint of the fins 26, 28 is larger than the inner dimensions of the channels. In inserting the fingers 18 into the channels, the sets of fins 26, 26 are resiliently deflected backwards to permit the insertion into the channels 42. The resilient nature of the fins 26, 28 causes the fins to exert a normal force F against the inner walls of the channels 42. The normal force causes a frictional force to be created which will resist axial forces that might be exerted on the end cap 10 tending to pull the cap away from engagement with the deck board 42. The flexibility of the fins 26, 28 permits the cap 10 to accommodate variations in the dimensions in the sizes and relative positioning of the channels 42.

It will be appreciated that the cumulative effect of each of the fins creating frictional forces on the inner walls in each of the plurality of channels 42, creates a significant overall frictional force to resist axial forces that would tend to disengage the end cap 10 from deck board 42.

Additionally, as shown in FIG. 1B, by having no direct physical interconnection between each fin 26a, 26b, 28a, 28b, and the fins adjacent their side edges, each fin can be displaced independently of the adjacent fins. The result is that for example, fins 28a, 28b, may be required to deflect to provide a total axial deflected distance X in order to be received into the channel 42; whereas fins 26a, 26b may only be required to deflect to provide a lesser total axial deflected distance Y in order to be received into the channel 42. As fins 26a, 26b, can move independently of fins 28a, 28b, the fins 26a, 26b are not forced to be deflected by an amount greater than Y, and so will retain contact with the inner channel wall of the channel 42 and thus fins 26a, 26b will contribute to enhancing the overall frictional force to resist disengagement of the cap member 10.

While in FIG. 1B the fins 26a, 26b, and 28a, 28b appear to deflect at their base, where they join to the wall portions, if the fins have profiles which gradually increase in width towards their base and are made of resilient material, it may be that the deflections will occur further at a location positioned upwards from the base, such that the force created by the resilient fins match the force exerted by the inner walls.

Apart from merely engaging the inner walls of the channels 42 to provide an outward force creating a frictional resistance, in other example embodiments the fins might additionally or alternatively be employed to engage and be received in slots formed in the inner walls of the channels 42. In such embodiments, there are the same or similar benefits of having independent movement of each of the fins.

It will be appreciated that the footprint of the fins 26, 28 does not necessarily have to match in shape to the shape of the inner wall of the channels. For example a plurality of fins which can move independently of each other and arranged with a footprint having a generally circular configuration, can be utilized in a generally square or triangular shaped channel wall. Likewise a generally elliptical fin footprint, can be used in a generally rectangular channel. Various other suitable configurations can be provided, so long as a suitable connection force is established to hold the fingers in the channels.

The end cap 10 may be configured such that when the fingers 18 are fully received into the channels 42, the inner surface 16 will abut the faces of plates 44a, 44b and webs 46 to provide a seal, thus inhibiting moisture, insects and debris from entering the hollow channels. The configuration may also be such that side end portions of plate 12 extend outwardly a sufficient amount so that the end channels 50 are covered over with aesthetic appeal benefits.

In some applications, such as in use with a deck board, the end cap 10 inserted into one deck board, may be adjacent to and may be in close proximity with the end cap used in an adjoining deck board (i.e. the ends of the bases may be positioned closely adjacent to each other).

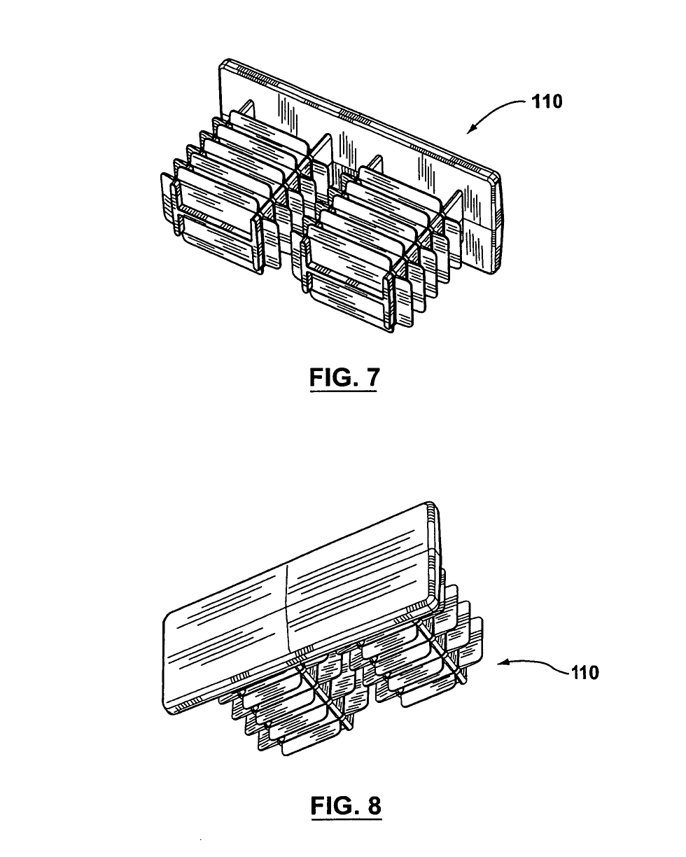

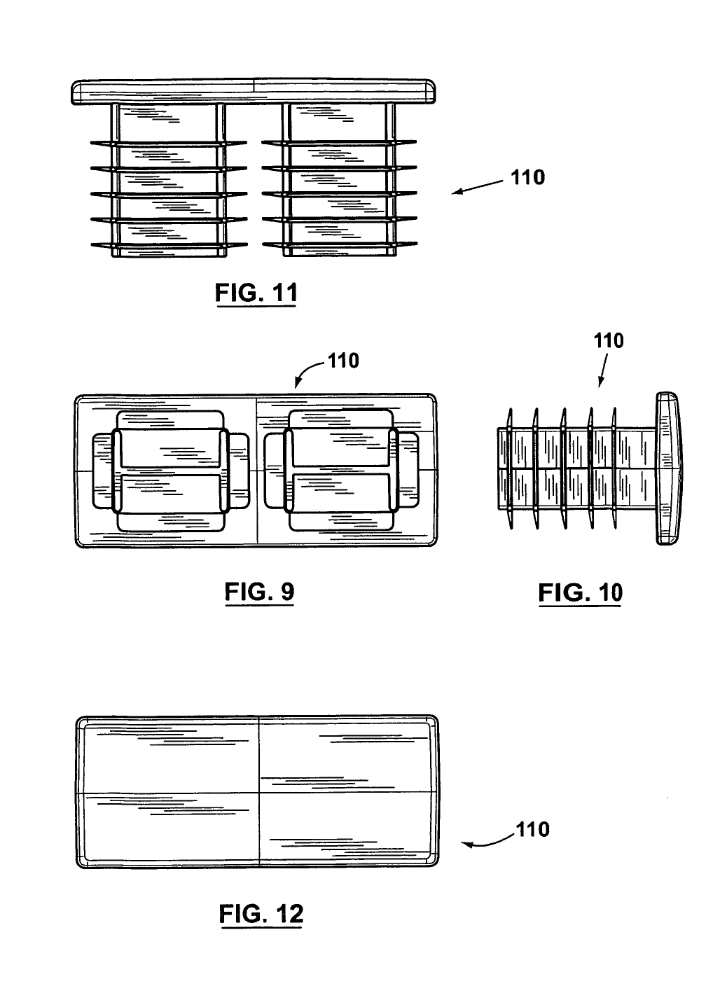

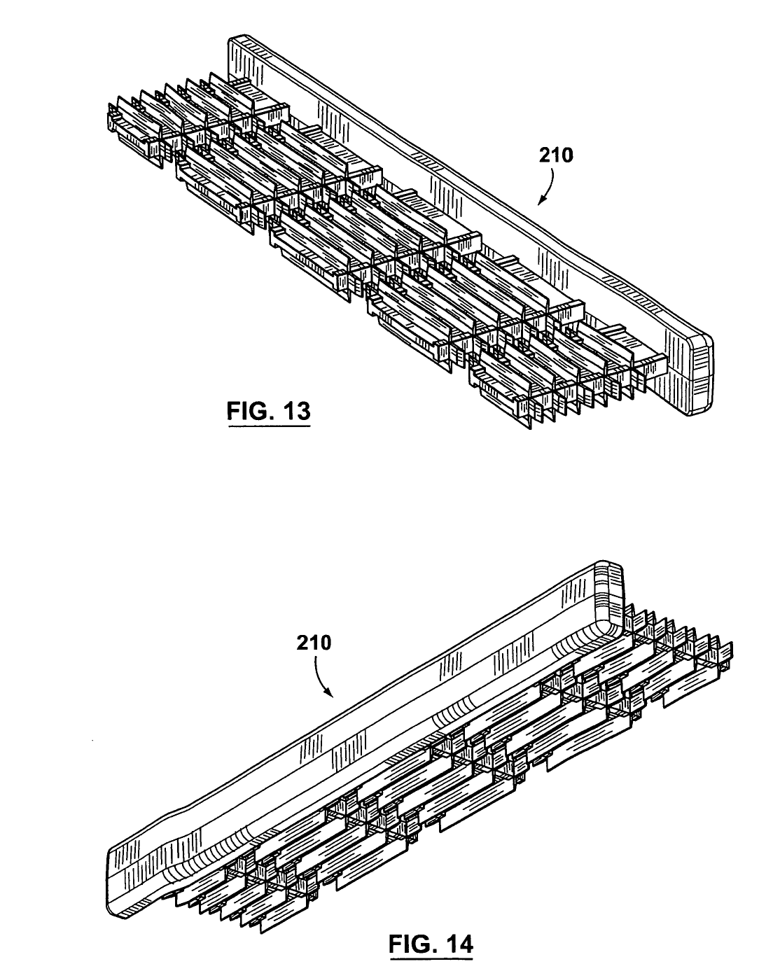

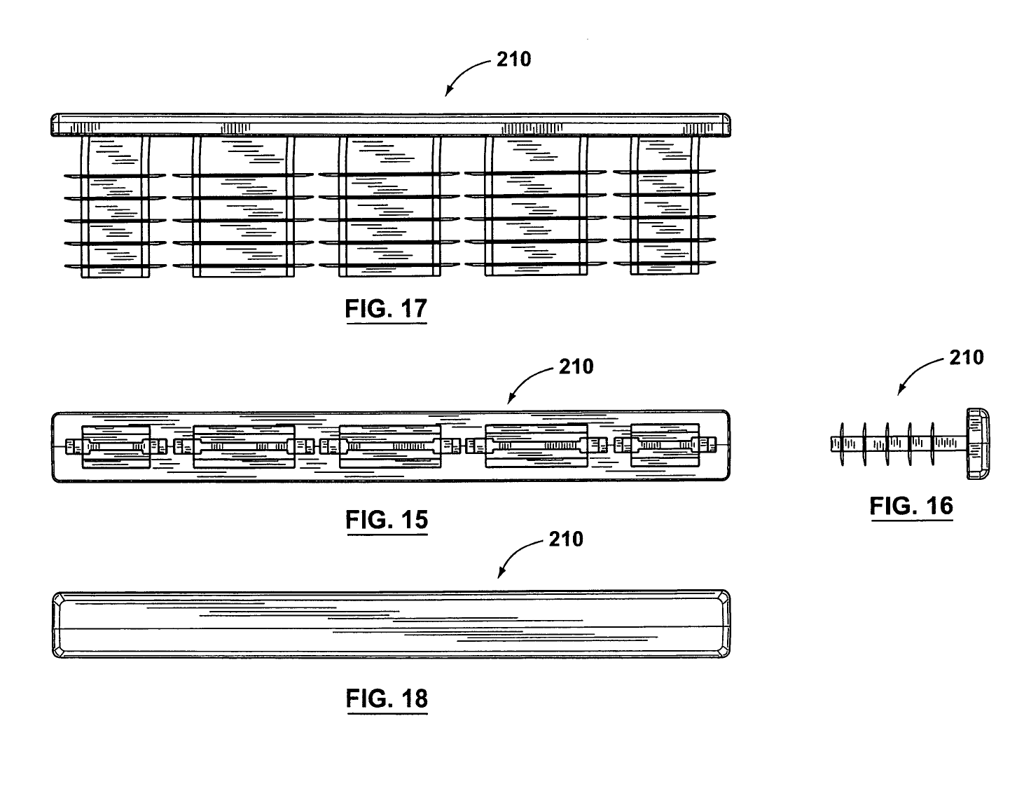

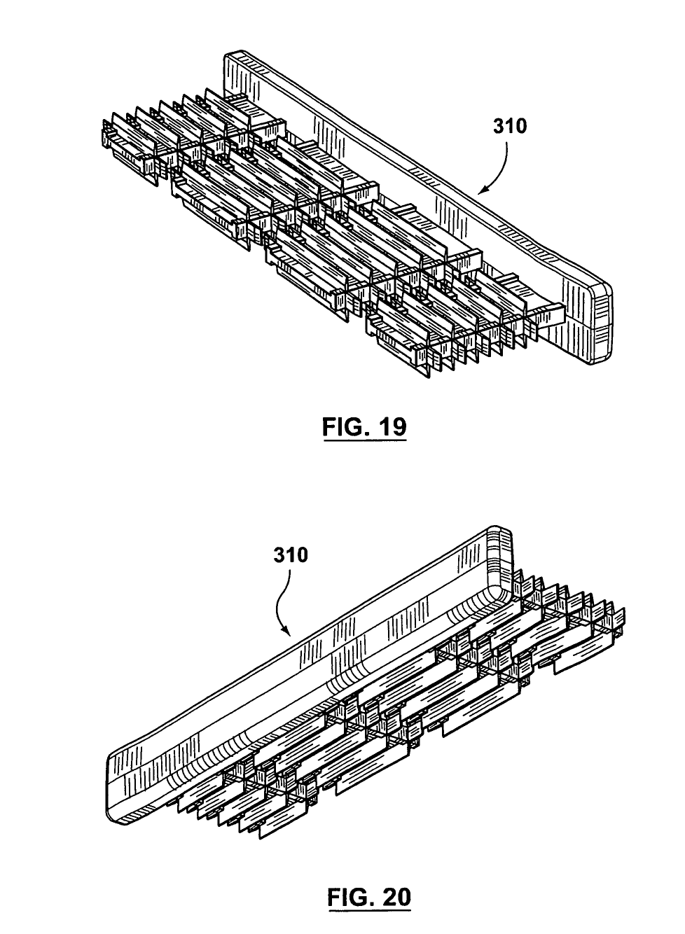

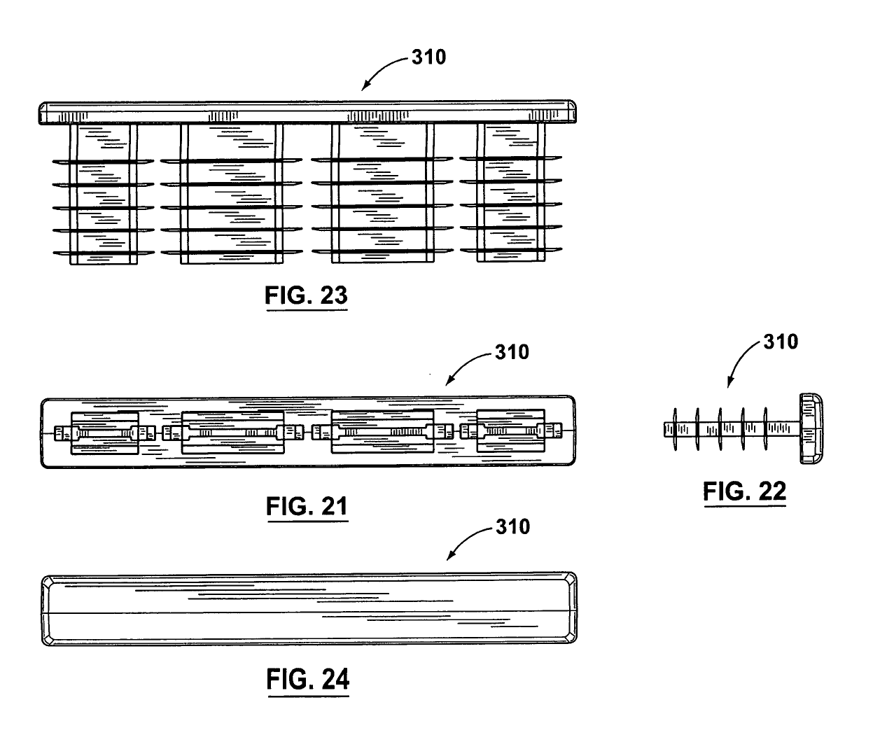

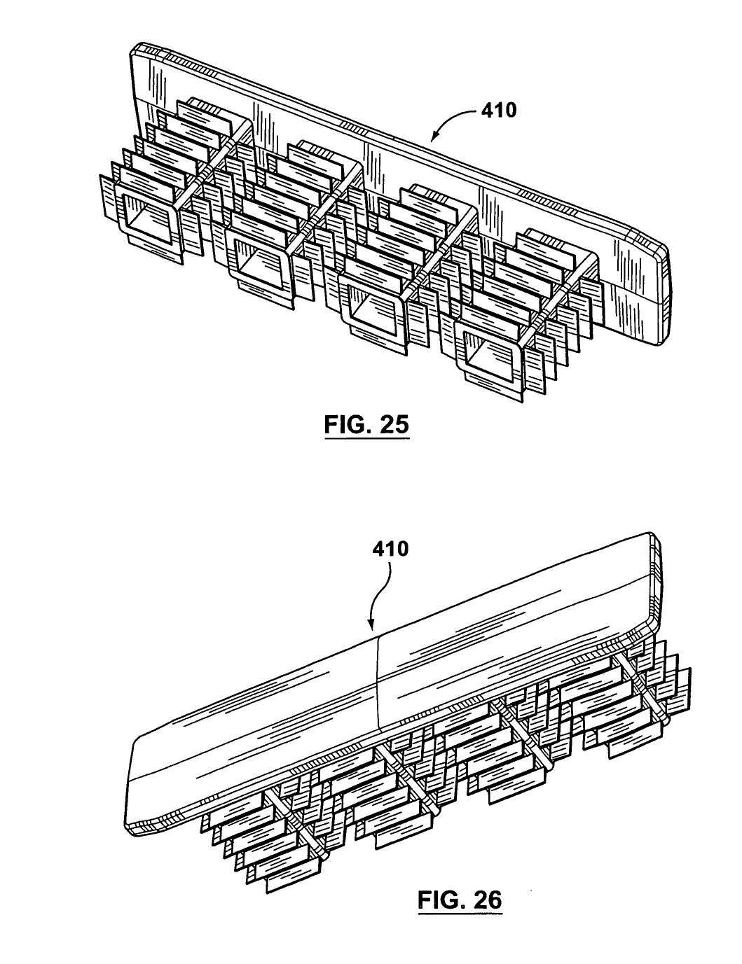

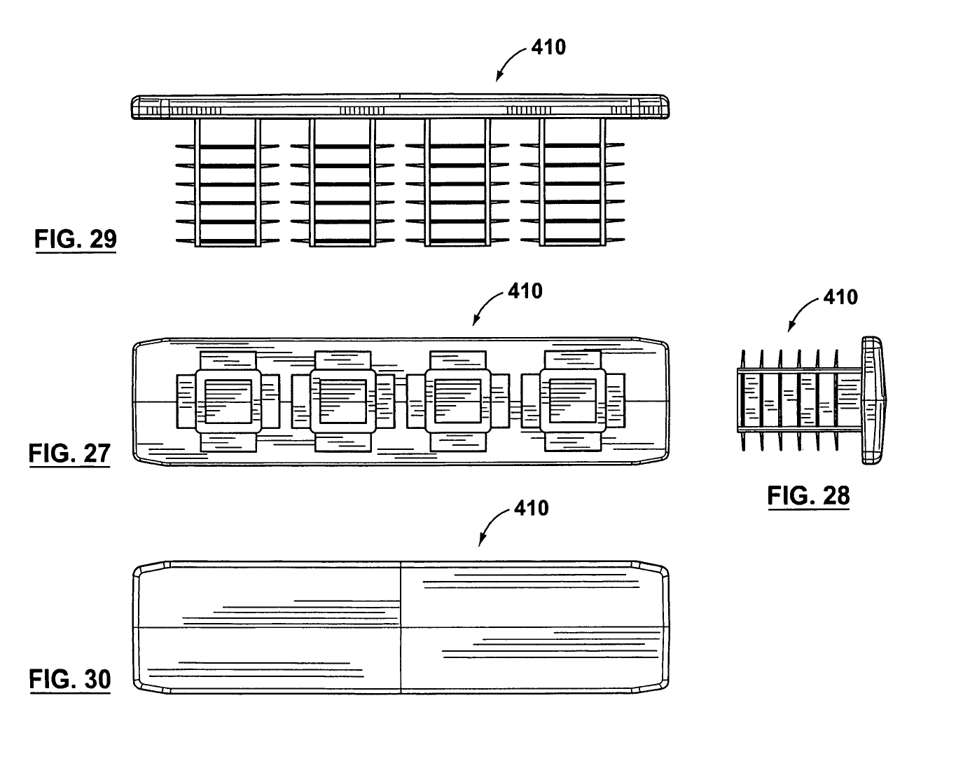

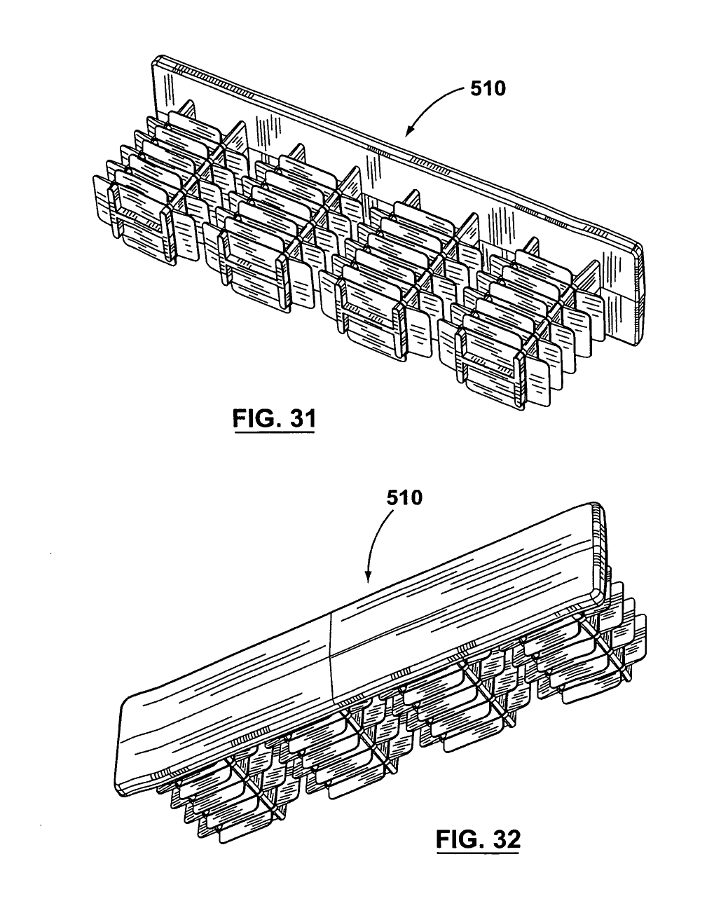

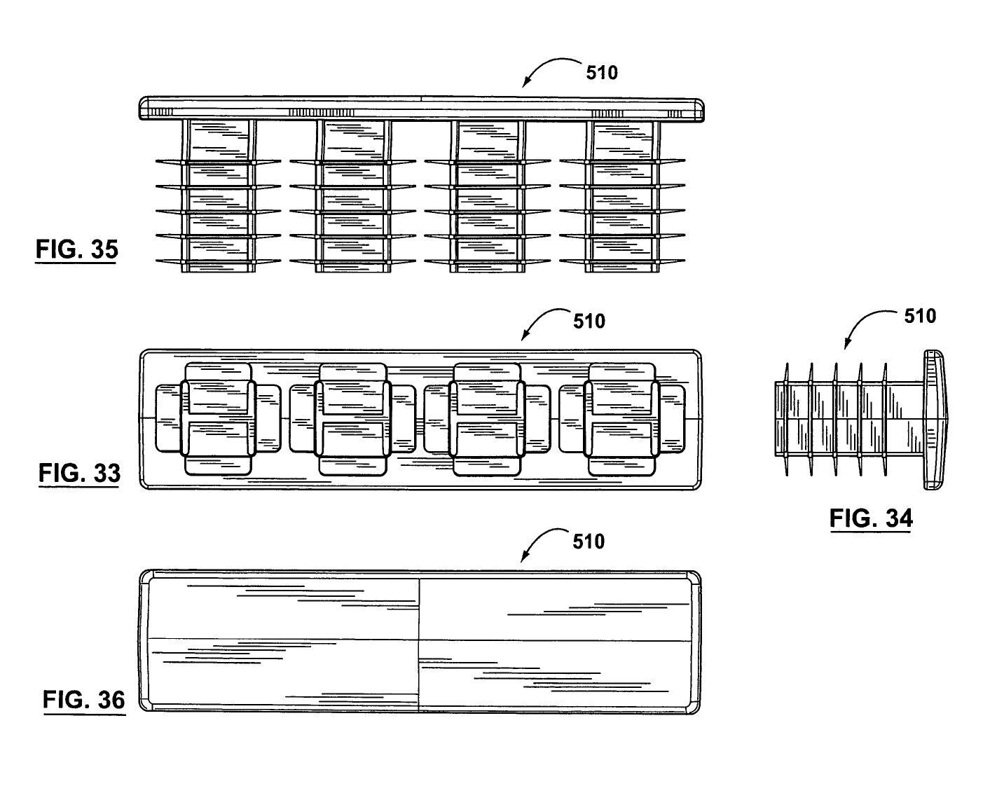

With reference now to FIGS. 7-12; FIGS. 13-18; FIGS. 19-24; FIGS. 25-30 and FIGS. 31-36 are five alternate embodiments 110, 210, 310, 410 and 510 are illustrated. In the alternate embodiment of cap member 410 of FIGS. 25-30, the finger member is formed as a rectangular hollow square section member, from which the fins extend outwards. It will be appreciated that the fingers could be formed in other configurations. For example, hollow channel profiles for the fingers could be provided for other configurations, such as for example, the embodiments in FIGS. 7-12; FIGS. 25-30; FIGS. 31-36 and possibly also the embodiments that are narrower such as for example as are disclosed in FIGS. 13-18; FIGS. 19-24

The foregoing relates to only exemplary embodiments of the invention, it being understood that numerous other modifications, variants, embodiments and changes are possible within the scope and spirit of the invention.

1. An end cap comprising
a) a base having at least one surface;
b) at least one finger extending outwards in a first direction from said at least one surface of said base; and
c) at least one set of fins comprising first and second flexible fins extending outwardly generally from said at least one finger in an orientation that is generally orthogonal to said first direction, said fins being generally positioned on opposite sides of said finger;
with at least a portion of said finger, said first and second fins being insertable into channel of a construction member such that each of said first and second fins is displaced and engages and exerts a force against an inner wall surface of said channel, whereby said end cap can be held in a fixed position relative to said construction member.

2. An end cap as claimed in claim 1 wherein said first and second fins are movable generally in said first direction, independently of each other.

3. An end cap as claimed in claim 1 wherein said first and second fins are resiliently displaceable generally in said first direction.

4. An end cap as claimed in claim 2 wherein said first and second fins are resiliently displaced.

5. An end cap as claimed in claim 4 wherein said first and second fins are positioned generally in a plane which is oriented generally orthogonal to said first direction.

6. An end cap as claimed in claim 1, wherein at least one finger comprises a plurality of fingers positioned in spaced relation to each other, each finger extending outwards generally in said first direction from said at least one surface of said base and each finger comprising at least one set of fins comprising first and second flexible fins extending outwardly generally from said at least one finger in an orientation that is generally orthogonal to said first direction, said fins being generally positioned on opposite sides of said finger; wherein at least a portion of each said finger and said first and second fins on each said finger is insertable into a respective channel associated with each finger of said construction member such that each of said first and second fins on each finger is displaced and engages and exerts a force against an inner wall surface of each said channel, whereby said end cap can be held in a fixed position relative to said construction member.

7. An end cap as claimed in claim 2 wherein said at least one set of fins further comprises a third flexible fin extending outwardly generally from said finger in an orientation that is generally orthogonal to said first direction and being movable independently of said first and second fins, said third fin being insertable with said finger into said channel of such that third fin is displaced and engages and exerts a force against an inner wall surface of said channel, whereby said end cap can be held in a fixed position relative to said construction member.

8. An end cap as claimed in claim 6 wherein said third fin is generally positioned in said plane.

9. An end cap as claimed in claim 7 wherein said third fin is resiliently displaceable generally in said first direction.

10. An end cap as claimed in claim 8 further wherein said at least one set comprises a fourth flexible fin extending outwardly generally from said finger in an orientation that is generally orthogonal to said first direction and being movable independently of said first, second and third fins, said fourth fin being insertable with said finger into said channel of such that fourth fin is displaced and engages and exerts a force against an inner wall surface of said channel, whereby said end cap can be held in a fixed position relative to said construction member.

11. An end cap as claimed in claim 10, wherein at least one finger comprises a plurality of fingers positioned in spaced relation to each other, each finger extending outwards generally in said first direction from said at least one surface of said base and each finger comprising a plurality of sets of fins, each set comprising first and second flexible fins extending outwardly generally from said at least one finger in an orientation that is generally orthogonal to said first direction, said fins being generally positioned on opposite sides of said finger; wherein at least a portion of each said finger and each of said first and second fins in each set on each said finger is insertable into a respective channel associated with each finger of said construction member such that each of said first and second fins on each set on each finger is displaced and engages and exerts a force against an inner wall surface of each said channel, whereby said end cap can be held in a fixed position relative to said construction member.

12. An end cap as claimed in claim 10 wherein said third and fourth fins are generally disposed opposite to each other on said finger.

13. An end cap as claimed in claim 1 wherein said at least one set comprises a plurality of sets of fins, each set of fins generally arranged in a plane separated from each of the other sets of fins.

14. An end cap as claimed in claim 13 wherein said at least one set comprises a plurality of sets of said first and second fins, each set of fins generally arranged in a plane separated from each of the other sets of fins.

15. An end cap as claimed in claim 10 wherein said at least one set comprises a plurality of sets of said fins, each set of fins generally arranged in a plane separated from each of the other sets of fins.

16. An end cap as claimed in claim 1 wherein said at least one finger comprises a plurality of fingers, and each of said plurality of fingers in insertable in a separate channel of said channel member.

17. An end cap as claimed in claim 1 wherein each of said first and second fins frictionally engages an inner wall of said channel.

18. An end cap comprising:
a) a base;
b) at least one finger extending in a first direction from said base;
c) a plurality of sets of fins each set of fins comprising a plurality of fins extending generally from said finger in an orientation that is generally orthogonal to said first direction,
with at least a portion of said finger, and said plurality of sets of fins being insertable into a channel of a construction member such that each of said fins of said plurality of fins engages and provides a frictional engagement with an inner wall surface of said channel, whereby said end cap can be held in a fixed position relative to said construction member.

19. An end cap as claimed in claim 18 wherein each of said plurality of fins in each set of fins is independently movable.

20. An end cap as claimed in claim 18 wherein said at least one finger comprises a plurality of fingers, and each of said plurality of fingers in insertable in a separate channel of said channel member.

21. An end cap as claimed in claim 19 wherein said first and second fins are resiliently displaceable and movable generally in said first direction.

22. An end cap as claimed in claim 20 wherein said first and second fins are resiliently displaceable and movable generally in said first direction.

23. An end cap comprising:
a) a base;
b) at least one finger extending in a first direction from said base;
c) a plurality of sets of flexible fins each set of fins comprising first and second fins extending generally from said finger in an orientation that is generally orthogonal to said first direction, each set of fins being positioned longitudinally along an axis oriented generally in said first direction wherein said first and second fins are movable independently of each other.

24. An end cap as claimed in claim 23 wherein said first and second fins are resiliently displaceable.
